(19) United States
(12) Patent Application Publication
(10) Pub. No.: US 2025/0073995 A1
(43) Pub. Date: Mar. 6, 2025

(54) Light Valve System with Gap Maintenance System

(71) Applicant: Seurat Technologies, Inc., Wilmington, MA (US)

(72) Inventors: Selim Elhadj, Lexington, MA (US); Yasaman Sargolzaeiaval, Woburn, MA (US); Zoey Samuel Davidson, Cambridge, MA (US)

(21) Appl. No.: 18/819,349

(22) Filed: Aug. 29, 2024

Related U.S. Application Data
(60) Provisional application No. 63/580,158, filed on Sep. 1, 2023.

(51) Int. Cl. B29C 64/286; B29C 64/153; B29C 64/268; B33Y 30/00; G02F 1/135

(52) U.S. Cl. CPC B29C 64/286; B29C 64/153; B29C 64/268; B33Y 30/00; G02F 1/1355

(57) ABSTRACT

A light valve can include a liquid crystal layer having a first and a second side. A first substrate is positioned in contact with the first side of the liquid crystal layer, with the first substrate having a first semiconductor layer. A second substrate is positioned in contact with the second side of the liquid crystal layer, with the second substrate having a second semiconductor transparent electrode layer and a second semiconductor layer. A plurality of laser transparent aperture support structures are positioned within the liquid crystal layer to contact both the first and the second substrate to generate a stable uniform gap under the force from the liquid crystal surface tension applied to substrate that are thin and compliant.

### RELATED APPLICATION

The present disclosure is part of a non-provisional patent application claiming the priority benefit of U.S. Patent Application No. 63/580,158, filed on Sep. 1, 2023, which is hereby incorporated by reference in its entirety.

### TECHNICAL FIELD

The present disclosure generally relates to the operation of high power-capable liquid crystal light valves suitable for use in additive manufacturing. More particularly, precise positioning of first and second substrates with respect to liquid crystal material is described.

### BACKGROUND

High power laser systems that are able to be operated at high fluence for long durations are useful for additive manufacturing and other applications. Such high-power lasers can provided patterned light beams using light valves. For example, a light valve (LV), is one type of spatial light modulator that can be used to impress information equally across the entire beam (1D modulation), provide variation across the beam to form parallelized optical channels (2D modulation), or provide variations across a volume of pixels/voxels channels (3D modulation). The information imposed on a read-beam can be in the form of amplitude, phase, polarization, wavelength, coherency, or quantum entanglement.

One type of light valve is a spatial light modulator (SLM), a light valve that uses refractive materials to impose spatially varying modulation on a beam of light. An SLM typically helps modulate the intensity of the light beam. Alternatively, cross-polarizers can be used to convert phase modulation into amplitude modulation. However, it is also possible to produce devices that modulate the polarization or phase of the beam or both the intensity and the phase simultaneously. Advantageously, an image created by an electrically addressed spatial light modulator can be created and changed electronically.

Light valves or other spatial light modulators can include a photorefractive liquid crystal layer between two transparent substrates or faced with at least one transparent substrate in a reflective design. Maintaining a uniform gap thickness is important to achieve spatially uniform transmittance of a beam through liquid crystal based electro-optical devices. Carefully polished and planarized thick and stiff substrates can be used to assemble liquid crystal cells that can maintain rigidity and gap thickness. The larger the area, the thicker the substrates must be to inherently self-supported maintain a flat surface for gap control and avoid sagging. Unfortunately, and particularly in larger format light valves, thick substrates cannot readily compensate for stress, warping or deformation, causing a non-uniform gap thickness across the aperture and reduced light valve performance. Also, the availability of suitable substrate materials with the thickness required may be lacking. Operating methods and structures are needed to improve or maintain light valves used in conjunction with high power lasers or at large format sizes.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates components of a transmissive light valve with laser transparent aperture support structures;

FIG. 1B illustrates components of a reflective light valve with laser transparent aperture support structures.

FIG. 1C illustrates a method of forming a light valve with laser transparent aperture support structures;

FIG. 2 illustrates a block diagram of a high fluence light valve based additive manufacturing system supporting a beam dump, a light valve, and a heat engine;

FIG. 3 illustrates a high fluence light valve based additive manufacturing system;

FIG. 4 illustrates another embodiment of a high fluence light valve based additive manufacturing system; and

FIG. 5 illustrates another embodiment of a high fluence light valve based additive manufacturing which incorporates a switchyard approach for recovery and further usage of waste energy.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

In the following disclosure, a light valve can include a liquid crystal layer having a first and a second side. A first substrate is positioned in contact with the first side of the liquid crystal layer, with the first substrate having a first semiconductor layer. A second substrate is positioned in contact with the second side of the liquid crystal layer, with the second substrate having a second semiconductor transparent electrode layer and a second semiconductor layer. A plurality of laser transparent aperture support structures are positioned within the liquid crystal layer to contact both the first and the second substrate. Additionally, in some embodiments, separate and distinct laser transparent aperture support structures are not required, with first and second substrates being thin and pliable enough to allow surface tension provided by the liquid crystal layers to maintain a substantially uniform gap that varies by less than a micrometer or so.

In some embodiments the first substrate further comprises a first semiconductor transparent electrode layer positioned in contact with the first semiconductor layer to form a transmissive light valve.

In some embodiments the first substrate further comprises a reflective layer positioned in contact with the first semiconductor layer to form a reflective light valve.

In some embodiments the liquid crystal layer is less than 100 micrometers, less than 10 micrometers, or less than 5 micrometers thick.

In some embodiments each substrate is less than 1 mm thick.

In some embodiments each substrate comprises at least one of a wide bandgap or ultra-wide bandgap semiconductor material.

In some embodiments the plurality of laser transparent aperture support structures comprise at least one of spacer balls, shims, and posts positioned within the liquid crystal layer and sized to maintain a uniform gap between the first and second substrates.

In some embodiments the first and second substrates and the liquid crystal layer are attached to form a monolithic block.

In some embodiments the first and second substrates and the liquid crystal layer are CTE matched to be within 10% of each other.

In some embodiments, a method of forming a light valve includes providing a liquid crystal layer having first and second sides. A plurality of laser transparent aperture support structures can be applied or otherwise positioned within the liquid crystal layer. A first electrode can be positioned on a first semiconductor layer to form a first substrate. The first semiconductor layer can be attached to the first side of the liquid crystal layer. A second transparent electrode can be positioned on a second semiconductor layer to form a second substrate and the second semiconductor layer arranged to contact the second side of the liquid crystal layer.

In some embodiments, an additive manufacturing system includes a laser system and a powder bed. A light valve is positioned to pattern light received from the laser system and direct the patterned light to the powder bed. In such embodiments the light valve includes a liquid crystal layer having a first and a second side. A first substrate is positioned in contact with the first side of the liquid crystal layer, with the first substrate having a first semiconductor layer. A second substrate is positioned in contact with the second side of the liquid crystal layer, with the second substrate having a second semiconductor transparent electrode layer and a second semiconductor layer. A plurality of laser transparent aperture support structures are positioned within the liquid crystal layer to contact both the first and the second substrate.

In some embodiments, the light valve forming a part of an additive manufacturing system can form a two-dimensional light pattern.

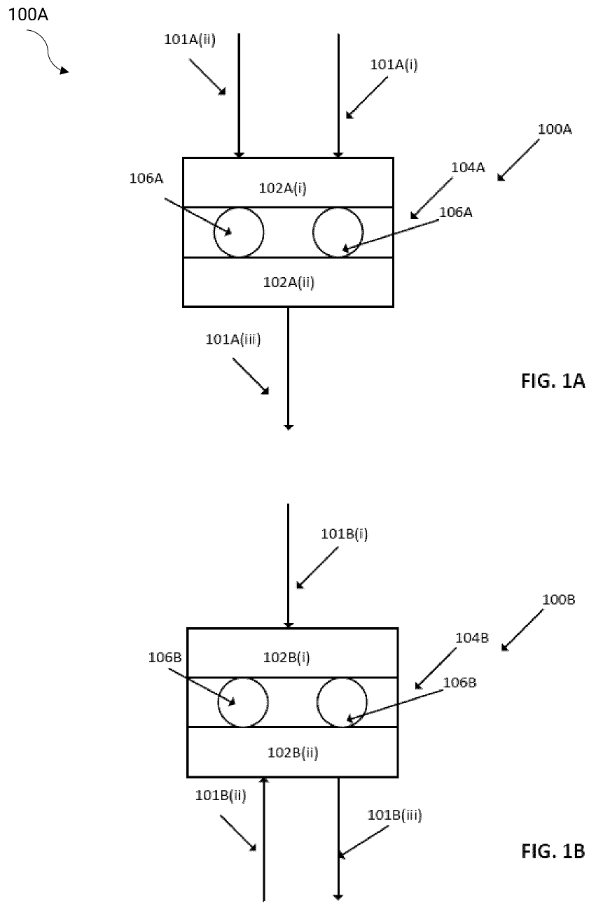

FIG. 1A illustrates one embodiment of a high fluence or power capable transmissive light valve suitable for use in additive manufacturing systems or other application benefiting from long light valve lifetime when used at energy fluences greater than 2 Joules/cm², kW levels of power, 10's of Joules energy over many cm² area. In one embodiment, a transmissive light valve system 100A includes a liquid crystal layer 104A. The liquid crystal layer 104A is positioned between first and second substrate layers 102A(i) and 102A(ii). In some embodiments the liquid crystal layer 104A and first and second substrate layers 102A(i) and 102A(ii) can be combined to form a monolithic block that resists delamination or layer separation and have CTE and refractive index matching within layers and between layers bracketing 104A. In some embodiments, the first and second substrate layers 102A(i) and 102A(ii) can have their respective coefficients of thermal expansion (CTE) matched to be within 10%, within 5%, or within 1% of each other Further, the first and second substrate layers 102A(i) and 102A(ii) can have their CTEs matched to be within 10%, within 5%, or within 1% of each other and the liquid crystal layer 104A.

Advantageously, closely matching CTEs of respective liquid crystal layer 104A and first and second substrate layers 102A(i) and 102A(ii) promotes even expansion of the transmissive light valve system 100A when heated by lasers(s). Similar and mostly transparent materials can be selected for first and second substrate layers 102A(i) and 102A(ii), providing balanced light absorption between layers and heating, such that layers experience the same temperature rise to minimize thermomechanical strain and stress cycle, fatigue, and damage to extend device lifetime.

In some embodiments, the levels of light-induced semiconductor excitation in the photoconductor layers can also be balanced or closely matched to within less than 1 percent to yield a top-to-bottom a more tightly bound electric field applied to the liquid crystal, which can improve patterning spatial resolution. In various embodiments the substrates can be thin enough to be compliant and self-adjusting when stacked with a fluid liquid crystal layer between the substrate layers. Gap uniformity can be achieved at least in part via the surface tension inward force between 2 substrates imposed by the liquid.

In some embodiments, the first substrate layer 102A(i) can be formed from a first transparent electrode layer and a first wide bandgap or ultra-wide bandgap semiconductor layer. Similarly, the second substrate layer 102A(ii) can be formed from a second transparent electrode layer and a second wide bandgap or ultra-wide bandgap semiconductor layer.

The thickness requirement of the substrate layers is dependent on one or more of the surface tension of the liquid crystal layer, the target gap thickness, the stiffness of the material, the surface shape, and local geometry. In various examples the thickness of the substrate layers is less than 1 mm. For example, the substrate thickness of each of first substrate layer 102A(i) and second substrate layer 102A(ii) may lie in the range 300-1000 μm. Compared to thicker substrate layers the inherent interfacial tension created pulls the two layers together. In some embodiments, gap uniformity can be achieved by using aperture support structures 106A within the liquid crystal layer, for example supporting shims, or spacer balls. The aperture support structures can be formed of silica or polymer micro-spheres, or other support structures, for example, polymer posts or other inorganic layers that counter the surface tension force. In an embodiment polymer posts or other inorganic layers can be produced photolithographically and then etched by reactive ion etching or other etching process. In an example, the spacer structures are transparent to laser light and therefore do not affect the operation of the light valve system.

Supported fluid gaps with surface tension can impose a uniform gap thickness under passive conditions but can also maintain gap uniformity under dynamic load conditions preventing both collapse of the gap or separation, thus maintaining device performance during operation. Additionally, in some embodiment, separate and distinct laser transparent aperture support structures are not required, with first and second substrates being thin and pliable enough to allow surface tension provided by the liquid crystal layers to maintain a substantially uniform gap that varies by less than a micrometer or so.

Interfacial tension force induced between the two substrate layers 102A(i) and 102A(ii) is a function of gap thickness, gap area, and surface tension properties of the liquid crystal layer 104A. Depending on the power spectrum of the spatial surface non-uniformity and the local geometry, and the rigidity of the non-flat surface areas of the substrates, the non-uniformity can be eliminated as they get pulled in against the aperture supports 106A. In devices with thin substrate layers 102A(i) and 102A(ii) used for high power laser applications, where generated heat in the liquid crystal layer 104A or adjacent substrates can cause mechanical deformation and lead to stress induced birefringence, maintaining a uniform thickness of the liquid crystal layer 104A can mitigate dynamic loading issues.

Use of aperture support structures 106A, positioned within the liquid crystal layer 104A between the first substrate layer 102A(i) and second substrate layer 102A(ii), aids in providing a uniform thickness of the liquid crystal layer 106A. Additionally, aperture support structures 106A can mitigate spatial surface non-uniformity of the first substrate layer 102A(i) and the second substrate layer 102A(ii) to achieve gap uniformity, which reduces constraints on the flatness required for the production of the substrate layers, or can reduce the substrate thickness required to maintain flatness. Gap uniformity can occur with non-flat substrates, as long as any surface non-uniformity is compensated for the first substrate layer 102A(i) and the second substrate layer 102A(ii) locally. For example, the aperture may have a curve, but with a uniform gap maintained by the spacer balls under the action of the surface tension force applied in all areas of the interstitial liquid crystal between two substrates.

The density of the support structures can be engineered based on the substrate thickness, surface shape, substrate stiffness, and surface nonuniformity. For example, support structures such as spacer balls can be applied uniformly within the liquid crystal layer gap at a fixed number per unit area. A variety of methods can be used to apply the spacer balls, for example, controlled puffing/spraying, by spin coating a solvent solution dispersed with spacer balls or using lithography techniques (e.g. photolithography or Reactive Ion Exchange (RIE) or a combination of techniques. The minimum required density of the spacer balls can be calculated by determining the force pulling the substrates together e.g., the spacer balls can be applied at a density of 1000/cm².

In operation, an addressing laser light 101A(i), the “write light”, induces a spatial pattern that can be transferred to a co-incident “read light” 101B(ii). In combination with polarizers, this image transfer process selectively results in blocking or transmitting laser light passing through the laser light valve system 100A. A high fluence, high power, and high energy input light 101A(ii) is directed to pass through the laser light valve system 100A, is spatially patterned, and becomes output light 101A(iii). This light can be directed to heat a powder bed suitable for additive manufacturing.

FIG. 1B illustrates a one embodiment of a high fluence, high power and high energy reflective light valve suitable for use in additive manufacturing systems or other application benefiting from long light valve lifetime when used at energy densities greater than 2 Joules/cm². In one embodiment, a reflective light valve system 100B includes a liquid crystal layer 104B. The liquid crystal layer 104B is positioned between the first and second substrate layers 102B(i) and 102B(ii). In some embodiments, the liquid crystal layer 104B and first and second substrate layers 102B(i) and 102B(ii) can be combined to form a monolithic block that resists delamination or layer separation have CTE and refractive index matching within layers and between layers bracketing 104B. In some embodiments, the first and second substrate layers 102B(i) and 102B(ii) can have their respective coefficients of thermal expansion (CTE) matched to be within 10%, within 5%, or within 1% of each other Further, the first and second substrate layers 102B(i) and 102B(ii) can have their CTEs matched to be within 10%, within 5%, or within 1% of each other and the liquid crystal layer 104A. Closely matching CTEs promote even expansion of the reflective light valve system 100B when heated by lasers(s), while, if using the same mostly transparent materials for each layer, will yield balanced light absorption between layers and heating, such that bottom and top layers experience the same temperature rise to minimize thermomechanical strain and stress cycle, fatigue, and damage and extend lifetime.

In some embodiments, the levels of light-induced semiconductor excitation in the photoconductor layers can also be balanced or closely matched to within less than 1 percent to yield a top-to-bottom a more tightly bound electric field applied to the liquid crystal, which can improve patterning spatial resolution. In various embodiments the substrates can be thin enough to be compliant and self-adjusting when stacked with a fluid liquid crystal layer between the substrate layers. Gap uniformity can be achieved via the surface tension imposed by the liquid crystal layer material.

In some embodiments, the first substrate layer 102B(i) can be formed from a first transparent electrode semiconductor layer including a first wide bandgap or ultra-wide bandgap photoconductor semiconductor and a reflective layer (e.g. dielectric mirror, or doped semiconductor multilayer). In some embodiments, the second substrate layer 102B(ii) can be formed from a second semiconductor transparent electrode layer and a wide bandgap or ultra-wide bandgap photoconductor semiconductor layer. In some embodiments a plurality of alignment layers and antireflective layers can be monolithically formed on at least one of the first transparent electrode and photoconductor layer, a first transparent conductive electrode, a second transparent electrode and photoconductor layer, and a second transparent conductive electrode.

The thickness of the substrate layers is dependent on one or more of the surface tension of the liquid crystal layer, the target gap thickness, the stiffness of the material, the surface shape, and local geometry. In various examples the thickness of the substrate layers is less than 1 mm. For example, the substrate thickness of each of first substrate layer 102B(i) and second substrate layer 102B(ii) may lie in the range 300-1000 μm. Compared to thicker substrate layers the inherent interfacial tension created pulls the two layers together. In some embodiments, gap uniformity can be achieved by using aperture support structures 106B within the liquid crystal layer, for example supporting shims, or spacer balls. The aperture support structures can be formed of silica or polymer micro-spheres, or other engineered support structures, for example, polymer posts or other inorganic layers that counter the surface tension force. In an embodiment polymer posts or other inorganic layers can be produced photolithographically and then etched by reactive ion etching or other etching process. In an example, the spacer structures are transparent to laser light and therefore do not affect the operation of the light valve system.

Supported fluid gaps with surface tension can impose a uniform gap thickness under passive conditions but can also maintain gap uniformity under dynamic load conditions preventing both collapse of the gap or separation, thus maintaining device performance during operation.

Interfacial tension force induced between the two substrate layers 102B(i) and 102B(ii) is a function of gap thickness, gap area, and surface tension properties of the liquid crystal layer 104B. Depending on the power spectrum of the spatial surface non-uniformity and the local geometry, and the rigidity of the non-flat surface areas of the substrates, the non-uniformity can be eliminated as they get pulled in against the aperture supports 106B. In devices with thin substrate layers 102B(i) and 102B(ii) used for high power laser applications, where generated heat in the liquid crystal layer 104B or adjacent substrates can cause mechanical deformation and lead to stress induced birefringence maintaining a uniform thickness of the liquid crystal layer 104B can mitigate these dynamic loading issues.

Aperture support structures 106B, positioned within the liquid crystal layer 104B between the first substrate layer 102B(i) and second substrate layer 102B(ii) aids a uniform thickness of the liquid crystal layer 106B, but also can mitigate the spatial surface non-uniformity of the first substrate layer 102B(i) and the second substrate layer 102B(ii) to achieve gap uniformity, which reduces constraints on the flatness or thickness required for the production of the substrate layers. Gap uniformity can occur with non-flat substrates, as long as any surface non-uniformity is compensated for the first substrate layer 102B(i) and the second substrate layer 102B(ii) locally. For example, the aperture may be curved, but with a uniform gap maintained by the spacer balls.

In a mode of operation shown in FIG. 1B an addressing laser light 101B(i), the “write light” induces a spatial pattern that can be transferred to a co-incident high fluence, high power, and high energy read light 101B(ii). In combination with polarizers, this image transfer process selectively results in blocking or transmitting laser light reflecting through the laser light valve system 100B becoming output light 101B(iii). This light can be directed to heat a powder bed suitable for additive manufacturing.

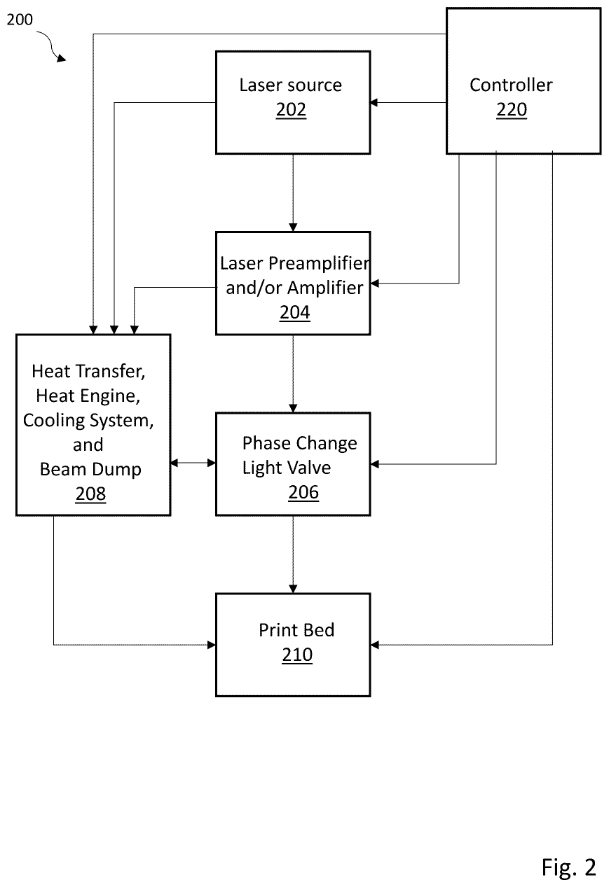

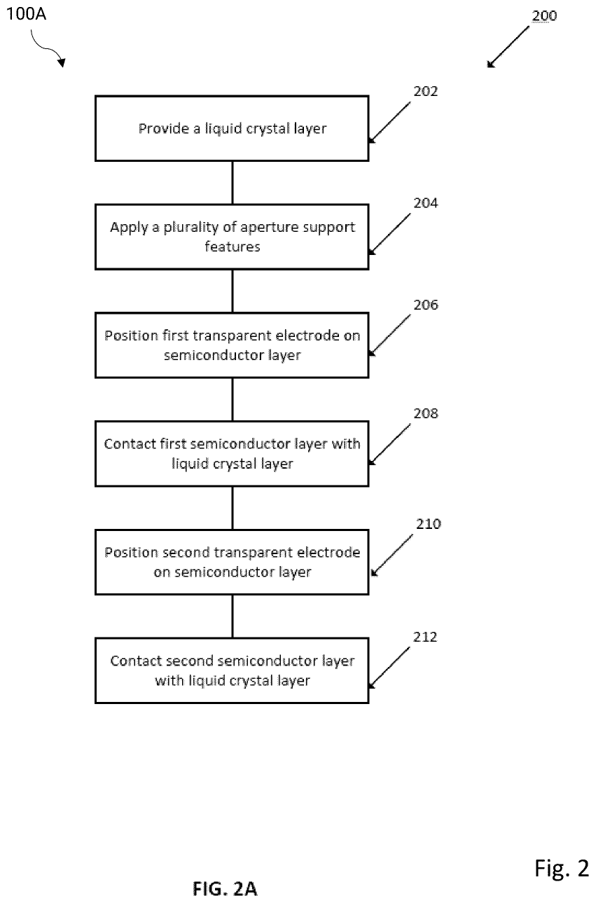

FIG. 2 illustrates an example process of manufacturing a high fluence, high power, and high energy reflective light valve. The process 200 can include providing 202 a liquid crystal layer.

A plurality of aperture support structures can be applied 204 within the liquid crystal layer using one or more of controlled puffing/spraying, by spin coating a solvent solution dispersed with spacer balls or using lithography techniques (e.g. photolithography or Reactive Ion Exchange (RIE) or a combination of techniques. The minimum required density of the spacer balls can be calculated by determining the force pulling the substrates together e.g., the spacer balls can be applied at a density of 1000/cm². The aperture support structures can be formed of silica or polymer micro-spheres, or other support structures, for example, polymer posts or other inorganic layers that counter the surface tension force. In an embodiment polymer posts or other inorganic layers can be produced photolithographically and then etched by reactive ion etching or other etching process. In an example, the spacer structures are transparent to laser light and therefore do not affect the operation of the light valve system.

A first transparent electrode can be positioned 206 on a photoconductor layer comprising a first semiconductor layer having a wide bandgap, the first semiconductor layer contacting 208 the liquid crystal layer. In some embodiments the first semiconductor layer can have a thickness of less than 1 mm. A second transparent electrode can be positioned 210 on a photoconductor layer comprising a second semiconductor layer having a wide bandgap, the second semiconductor layer contacting 212 the liquid crystal layer. In some embodiments the first semiconductor layer can have a thickness of less than 1 mm.

In some embodiments one or more anti-reflective coatings can be applied to the first and second semiconductors layers.

A wide range of lasers of various wavelengths can be used in combination with the described light valve system. In some embodiments, possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO₄) laser, Neodymium doped yttrium calcium oxoborateNd:YCa₄O(BO₃)³ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm⁺³:Glass) solid-state laser, Chromium doped chrysoberyl (alexandrite) laser, Erbium doped anderbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

FIG. 2 illustrates use of a light valve such as disclosed herein in an additive manufacturing system 200. A laser source 202 directs a laser beam through a laser preamplifier and/or amplifier 204 into a light valve 206. After patterning, light can be directed into a print bed 210. In some embodiments, heat or laser energy from laser source 202, laser preamplifier and/or amplifier 204, or an actively cooled light valve 206 can be actively or passively transferred to a heat transfer, heat engine, cooling system, and beam dump 208. Overall operation of the light valve based additive manufacturing system 200 can controlled by one or more controllers 220 that can modify laser power and timing.

In some embodiments, various preamplifiers or amplifiers 204 are optionally used to provide high gain to the laser signal, while optical modulators and isolators can be distributed throughout the system to reduce or avoid optical damage, improve signal contrast, and prevent damage to lower energy portions of the system 200. Optical modulators and isolators can include, but are not limited to Pockels cells, Faraday rotators, Faraday isolators, acousto-optic reflectors, or volume Bragg gratings. Pre-amplifier or amplifiers 204 could be diode pumped or flash lamp pumped amplifiers and configured in single and/or multi-pass or cavity type architectures. As will be appreciated, the term pre-amplifier here is used to designate amplifiers which are not limited thermally (i.e. they are smaller) versus laser amplifiers (larger). Amplifiers will typically be positioned to be the final units in a laser system 200 and will be the first modules susceptible to thermal damage, including but not limited to thermal fracture or excessive thermal lensing.

Laser pre-amplifiers can include single pass pre-amplifiers usable in systems not overly concerned with energy efficiency. For more energy efficient systems, multi-pass pre-amplifiers can be configured to extract much of the energy from each pre-amplifier 204 before going to the next stage. The number of pre-amplifiers 204 needed for a particular system is defined by system requirements and the stored energy/gain available in each amplifier module. Multi-pass pre-amplification can be accomplished through angular multiplexing or polarization switching (e.g. using waveplates or Faraday rotators).

Alternatively, pre-amplifiers can include cavity structures with a regenerative amplifier type configuration. While such cavity structures can limit the maximum pulse length due to typical mechanical considerations (length of cavity), in some embodiments “white cell” cavities can be used. A “white cell” is a multi-pass cavity architecture in which a small angular deviation is added to each pass. By providing an entrance and exit pathway, such a cavity can be designed to have an extremely large number of passes between entrance and exit allowing for large gain and efficient use of the amplifier. One example of a white cell would be a confocal cavity with beams injected slightly off axis and mirrors tilted such that the reflections create a ring pattern on the mirror after many passes. By adjusting the injection and mirror angles the number of passes can be changed.

Amplifiers are also used to provide enough stored energy to meet system energy requirements, while supporting sufficient thermal management to enable operation at system required repetition rate whether they are diode or flashlamp pumped. Both thermal energy and laser energy generated during operation can be directed for heat transfer into a heat engine, cooling system, or beam dump 208.

Amplifiers can be configured in single and/or multi-pass or cavity type architectures. Amplifiers can include single pass amplifiers usable in systems not overly concerned with energy efficiency. For more energy efficient systems, multi-pass amplifiers can be configured to extract much of the energy from each amplifier before going to the next stage. The number of amplifiers needed for a particular system is defined by system requirements and the stored energy/gain available in each amplifier module. Multipass pre-amplification can be accomplished through angular multiplexing, polarization switching (waveplates, Faraday rotators). Alternatively, amplifiers can include cavity structures with a regenerative amplifier type configuration. As discussed with respect to pre-amplifiers, amplifiers can be used for power amplification.

In some embodiments, thermal energy and laser energy generated during operation of system 200 can be directed into the heat transfer, heat engine, cooling system, and beam dump 208. Alternatively, or in addition, in some embodiments the beam dump 208 can be a part of a heat transfer system to provide useful heat to other industrial processes. In still other embodiments, the heat can be used to power a heat engine suitable for generating mechanical, thermoelectric, or electric power. In some embodiments, waste heat can be used to increase temperature of connected components. As will be appreciated, laser flux and energy can be scaled in this architecture by adding more pre-amplifiers and amplifiers with appropriate thermal management and optical isolation. Adjustments to heat removal characteristics of the cooling system are possible, with increase in pump rate or changing cooling efficiency being used to adjust performance.

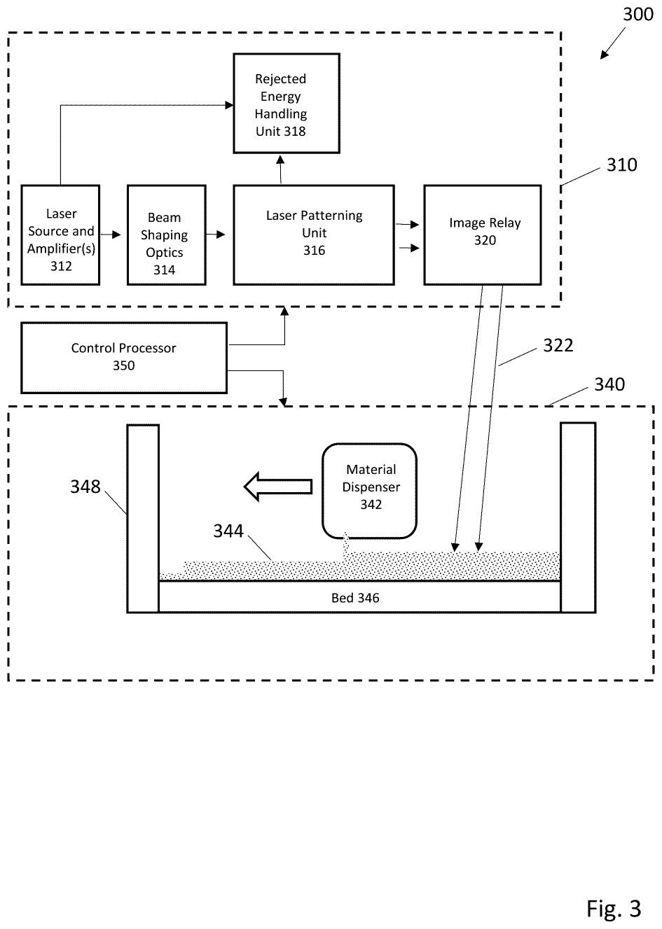

FIG. 3 illustrates an additive manufacturing system 300 that can accommodate light valves as described in this disclosure. As seen in FIG. 3, a laser source and amplifier(s) 312 can include light valves and laser amplifiers and other components such as previously described. As illustrated in FIG. 3, the additive manufacturing system 300 uses lasers able to provide one- or two-dimensional directed energy as part of a laser patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The laser patterning system 310 uses laser source and amplifier(s) 312 to direct one or more continuous or intermittent energy beam(s) toward beam shaping optics 314. After shaping, if necessary, the beam is patterned by a laser patterning unit 316 that includes either a transmissive or reflective light valve, with generally some energy being directed to a rejected energy handling unit 318. The rejected energy handling unit can utilize heat provided by active cooling of light.

Patterned energy is relayed by image relay 320 toward an article processing unit 340, in one embodiment as a two-dimensional image 322 focused near a bed 346. The bed 346 (with optional walls 348) can form a chamber containing material 344 (e.g. a metal powder) dispensed by material dispenser 342. Patterned energy, directed by the image relay 320, can melt, fuse, sinter, amalgamate, change crystal structure, influence stress patterns, or otherwise chemically or physically modify the dispensed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, micro-lenses, and refractive or diffractive optical elements.

Laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source, light valve(s), and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system can be utilized in, for example and not limited to, laser-based additive manufacturing techniques where a mask is applied to the light. Advantageously, in various embodiments in accordance with the present disclosure, the thrown-away energy can be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid-state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

Article processing unit 340 can include a walled chamber 348 and bed 344 (collectively defining a build chamber), and a material dispenser 342 for distributing material. The material dispenser 342 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2, C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units or build chambers, each having a build platform to hold a powder bed, can be used in conjunction with multiple optical-mechanical assemblies arranged to receive and direct the one or more incident energy beams into the build chambers. Multiple chambers allow for concurrent printing of one or more print jobs inside one or more build chambers. In other embodiments, a removable chamber sidewall can simplify removal of printed objects from build chambers, allowing quick exchanges of powdered materials. The chamber can also be equipped with an adjustable process temperature control. In still other embodiments, a build chamber can be configured as a removable printer cartridge positionable near laser optics. In some embodiments a removable printer cartridge can include powder or support detachable connections to a powder supply. After manufacture of an item, a removable printer cartridge can be removed and replaced with a fresh printer cartridge.

In another embodiment, one or more article processing units or build chambers can have a build chamber that is maintained at a fixed height, while optics are vertically movable. A distance between final optics of a lens assembly and a top surface of powder bed can be managed to be essentially constant by indexing final optics upwards, by a distance equivalent to a thickness of a powder layer, while keeping the build platform at a fixed height. Advantageously, as compared to vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed can be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or build chambers with a build platform that supports a powder bed capable of tilting, inverting, and shaking to separate the powder bed substantially from the build platform in a hopper. The powdered material forming the powder bed can be collected in a hopper for reuse in later print jobs. The powder collecting process can be automated and vacuuming or gas jet systems are also used to aid powder dislodgement and removal.

Some embodiments, the additive manufacturing system can be configured to easily handle parts longer than an available build chamber. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture, and clean-up (e.g., separation and/or reclamation of unused or unamalgamated granular material) can be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having an article processing unit or build chamber contained within an enclosure, the build chamber being able to create a part having a weight greater than or equal to 2,000 kilograms. A gas management system can maintain gaseous oxygen within the enclosure at concentrations below the atmospheric level. In some embodiments, a wheeled vehicle can transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection can be performed periodically, and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to a variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

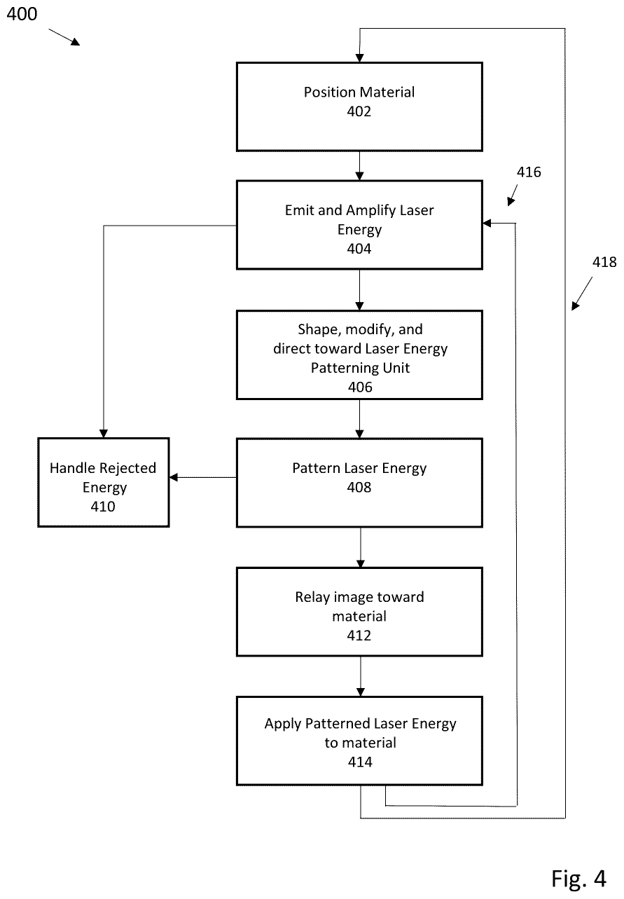

One embodiment of operation of a manufacturing system supporting use of a light valve suitable for additive or subtractive manufacture is illustrated in FIG. 4. In this embodiment, a flow chart 400 illustrates one embodiment of a manufacturing process supported by the described optical and mechanical components. In step 402, material is positioned in a bed, chamber, or other suitable support. The material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned by a light valve, with energy not forming a part of the pattern being handled in step 410 (this can include use of a beam dump as disclosed with respect to FIG. 2 and FIG. 3 that provide conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 416) until the image (or different and subsequent image) has been applied to all necessary regions of a top layer of the material. When application of energy to the top layer of the material is finished, a new layer can be applied (loop 418) to continue building the 3D structure. These process loops are continued until the 3D structure is complete, when remaining excess material can be removed or recycled.

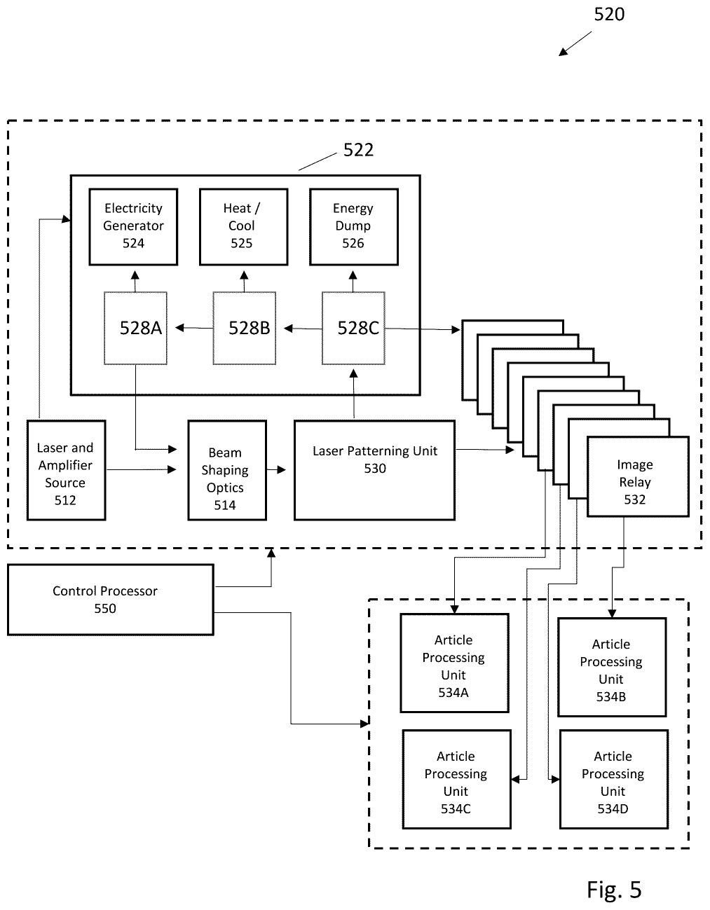

FIG. 5 is one embodiment of an additive manufacturing system that includes a light valve and a switchyard system enabling reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed is inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units. 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention can be practiced in the absence of an element/step not specifically disclosed herein.

1. A light valve, comprising:
a liquid crystal layer having a first and a second side;
a first substrate positioned in contact with the first side of the liquid crystal layer, with the first substrate having a first semiconductor layer; and
a second substrate positioned in contact with the second side of the liquid crystal layer, with the second substrate having a second semiconductor transparent electrode layer and a second semiconductor layer; and
a plurality of laser transparent aperture support structures positioned within the liquid crystal layer to contact both the first and the second substrate.

2. The light valve of claim 1, wherein the first substrate further comprises a first semiconductor transparent electrode layer positioned in contact with the first semiconductor layer to form a transmissive light valve.

3. The light valve of claim 1, wherein the first substrate further comprises a reflective layer positioned in contact with the first semiconductor layer to form a reflective light valve.

4. The light valve of claim 1, wherein the liquid crystal layer is at least one of less than liquid crystal layer is less than 100 micrometers, less than 10 micrometers, or less than 5 micrometers thick.

5. The light valve of claim 1, wherein each substrate is less than 1 mm thick.

6. The light valve of claim 1, wherein each substrate comprises at least one of a wide bandgap and ultra-wide bandgap semiconductor material.

7. The light valve of claim 1, wherein the plurality of laser transparent aperture support structures comprise at least one of spacer balls, shims, and posts positioned within the liquid crystal layer and sized to maintain a uniform gap between the first and second substrates.

8. The light valve of claim 1, wherein the first and second substrates and the liquid crystal layer are attached to form a monolithic block.

9. The light valve of claim 1, wherein the first and second substrates and the liquid crystal layer are CTE matched to be within 10% of each other.

10. A method of forming a light valve, comprising:
providing a liquid crystal layer having first and second sides;
applying a plurality of laser transparent aperture support structures into the liquid crystal layer;
positioning a first electrode on a first semiconductor layer to form a first substrate;
contacting the first semiconductor layer with the first side of the liquid crystal layer;
positioning a second transparent electrode on a second semiconductor layer to form a second substrate; and
contacting the second semiconductor layer with the second side of the liquid crystal layer.

11. The method of claim 10, wherein the first substrate further comprises a first semiconductor transparent electrode layer positioned in contact with the first semiconductor layer to form a transmissive light valve.

12. The method of claim 10, wherein the first substrate further comprises a reflective layer positioned in contact with the first semiconductor layer to form a reflective light valve.

13. The method of claim 10, wherein the liquid crystal layer is less than 1 mm thick.

14. The method of claim 10, wherein each substrate is less than 1 mm thick.

15. The method of claim 10, wherein each substrate comprises at least one of a wide bandgap and ultra-wide bandgap semiconductor material.

16. The method of claim 10, wherein the plurality of laser transparent aperture support structures comprises at least one of spacer balls, shims, and posts positioned within the liquid crystal layer and sized to maintain a uniform gap between the first and second substrates.

17. The method of claim 10, wherein the first and second substrates and the liquid crystal layer are attached to form a monolithic block.

18. The method of claim 10, wherein the first and second substrates and the liquid crystal layer are CTE matched to be within 10% of each other.

19. An additive manufacturing system, comprising:
a laser system;
a powder bed;
a light valve positioned to pattern light received from the laser system and direct the patterned light to the powder bed, wherein the light valve further comprises
a liquid crystal layer having a first and a second side;
a first substrate positioned in contact with the first side of the liquid crystal layer, with the first substrate having and a first semiconductor layer; and
a second substrate positioned in contact with the second side of the liquid crystal layer, with the second substrate having a second semiconductor transparent electrode layer and a second semiconductor layer; and
a plurality of laser transparent aperture support structures positioned within the liquid crystal layer to contact both the first and the second substrate.

20. The additive manufacturing system of claim 19, wherein the light valve can form a two-dimensional light pattern.

21. A light valve, comprising:
a liquid crystal layer having a first and a second side;
a first substrate positioned in contact with the first side of the liquid crystal layer, with the first substrate having a first semiconductor layer;
a second substrate positioned in contact with the second side of the liquid crystal layer, with the second substrate having a second semiconductor transparent electrode layer and a second semiconductor layer; and wherein
the liquid crystal layer is within a uniform gap contacting both the first and the second substrate.

22. The light valve of claim 21, wherein the liquid crystal layer is at least one of less than liquid crystal layer is less than 100 micrometers, less than 10 micrometers, or less than 5 micrometers thick.

23. The light valve of claim 21, wherein the uniform gap containing the liquid crystal layer varies in thickness by less than a micrometer.
